(19) United States
(12) Patent Application Publication
(10) Pub. No.: US 2025/0277686 A1
(43) Pub. Date: Sep. 4, 2025

(54) SYSTEM FOR DETECTING A MEASUREMENT VARIABLE OF A FLUID CONDUCTED IN A FLUID-CONDUCTING LINE, FLOW-THROUGH DEVICE FOR ARRANGING ON A FLUID-CONDUCTING LINE AND FOR ATTACHING A FLOWMETER, AND USE OF A FLOW-THROUGH DEVICE

(71) Applicant: Sartorius Stedim Biotech GmbH, Göttingen (DE)

(72) Inventors: Matthias Bode, Krebeck-Renshausen (DE); Norbert Aue, Bovenden (DE); Sina Götemann, Bovenden (DE); Ana Raquel Santos de Matos Fortuna, Göttingen (DE); Svenja Firneisen, Rosdorf (DE)

(73) Assignee: Sartorius Stedim Biotech GmbH, Göttingen (DE)

(21) Appl. No.: 18/862,124

(22) PCT Filed: May 2, 2023
(86) PCT No.: PCT/EP2023/061465

§ 371 Date: Oct. 31, 2024

(30) Foreign Application Priority Data
May 4, 2022 (EP) 22171522.0

(51) Int. Cl. G01F 1/66; G01F 15/18

(52) U.S. Cl. CPC G01F 1/662; G01F 15/185

(57) ABSTRACT

A system for detecting a measurement variable of a fluid being conducted in a fluid-conducting line, having a flowmeter for detecting the measurement variable, a flow-through device for arranging on the fluid-conducting line and for attaching the flowmeter. The flowmeter has a first and second connection and a measurement region which is arranged between the first connection and the second connection and which can be coupled to the flowmeter. The first connection, the measurement region, and the second connection define a flow path for the fluid through the flow-through device.

The present invention relates to a system for detecting a measurement variable of the fluid being conducted in a fluid-conducting line, a flow-through device for arranging on a fluid-conducting line and for attaching a flowmeter, and the use of a flow-through device.

In a large number of methods in the automation of industrial or laboratory processes, flow measurements are carried out in pipe, tube, and hose systems to monitor the processes. In-line flow measuring devices and clamp-on flow measuring devices, among others, are used for flow measurements. In-line flow measuring devices have measuring sensors installed in the flow profile of the fluid or medium to be measured, whereas clamp-on flow measuring devices are placed and clamped from the outside onto a line, pipe, or hose that conducts the fluid or medium.

Furthermore, clamp-on flow measuring devices are known in which a flow-through device is installed in a plastic hose conducting the fluid or medium, so that the fluid or medium flows through the flow-through device. A flow measuring device is attached to this flow-through device, which measuring device inputs a suitable input signal, e.g. an ultrasonic signal, into the flow-through device installed in the plastic hose and carries out the flow measurement based on an output signal received via the flow-through device, which output signal is based on the input signal.

The present invention is based on the object of providing a system for detecting a measurement variable of the fluid conducted by a fluid-conducting line, which makes it possible to improve the accuracy of a flow measurement. Furthermore, it is an object of the invention to propose a flow-through device for arranging on a fluid-conducting line and for attaching a flowmeter, as well as a use of the flow-through device, which enable the measurement variable to be recorded as accurately as possible.

This object is achieved by the subject matter of the independent claims. Preferred embodiments are achieved in the dependent claims.

A first aspect relates to a system for detecting a measurement variable of the fluid conducted by a fluid-conducting line, said system having:
a flowmeter, in particular an ultrasonic flowmeter, for detecting the measurement variable,
a flow-through device for arranging on the fluid-conducting line and for attaching the flowmeter for detecting the measurement variable of the fluid conducted by the line, said flow-through device has:
a first and a second connection by means of which the flow-through device can be connected to the fluid-conducting line,
a measurement region arranged between the first connection and the second connection, which can be coupled to the flowmeter for detecting the measurement variable, wherein the first connection, the measurement region and the second connection define a flow path for the fluid through the flow-through device,
   wherein the measurement region has at least two contact surfaces, which extend at least partially along the flow path, for contacting the flowmeter, wherein the at least two contact surfaces are designed to secrete a coupling agent when a contact pressure is applied, and
   wherein the flowmeter is designed such that by coupling the flowmeter to the measurement region, the flowmeter exerts at least the contact pressure on the at least two contact surfaces.

Advantageously, the secreting of the coupling agent enables improved signal transmission between the flowmeter and the contact surfaces, which leads to better detection of the measurement variable. In particular, in an ultrasonic flowmeter in which the flowmeter couples an input signal, preferably an ultrasonic signal, into the measurement region via the contact surfaces and receives an output signal based on the input signal, the coupling agent leads to better signal transmission in the signal path. In particular, the coupling agent, which is preferably liquid, reduces gas phases in the signal path. Gas phases in the signal path arise in particular from cavities that are filled with a gaseous fluid, such as ambient air, and lie between the contact surfaces and the flowmeter. Due to the secretion of the contact agent, the gaseous fluid can be displaced by the coupling agent, so that there is now a liquid phase in the signal path, which improves signal transmission.

In particular, the first and second connections as well as the measurement region arranged between the first and second connections can have a channel, or flow channel, which defines the flow path and through which the fluid or medium flows. As a fluid-conducting line which can be connected to the first and second connection, pipes or hoses, for example made of plastic, can be provided. For example, in order to attach the flow-through device to the line, it may be provided to separate the line so that a first open end of the line is connected to the first connection and a second open end of the line is connected to the second connection so that the flow-through device connects the first open end and the second open end of the line to each other.

Preferably, the flow path or channel is elongated and runs essentially in a straight line. In particular, it can be provided that the flow path is not bent or curved, for example does not have a 90° bend, so that the main flow direction of the fluid or medium through the flow-through device is substantially constant.

The fluid or medium can in particular be liquid, and the fluid or medium can also have solid components, such as particles or cell components. However, the invention is not limited to fluids in liquid form.

The flow-through device and/or the flowmeter are used in particular for monitoring industrial and/or laboratory processes and serve to monitor the processes based on a flow measurement of a fluid or medium flowing through line, pipe, and/or hose systems. The flow-through device can be used in particular as a single-use (SU) device.

Preferably, the flowmeter can couple an input signal, for example an ultrasonic signal, into the measurement region, preferably via a contact surface of the at least two contact surfaces, and receive an output signal based on the input signal via the measurement region, preferably via another contact surface of the at least two contact surfaces. Based on the input and output signal, the flowmeter can record a measurement variable relevant for the flow measurement, e.g. a volume flow or mass flow measurement.

Preferably, it can be provided that the at least two contact surfaces comprise an elastomer and/or thermoplastic elastomer, wherein optionally the thermoplastic elastomer is selected from the group consisting of polyether block amides (thermoplastic polyether block amides (TPA)), (co)polyesters (thermoplastic copolyester elastomers (TPC)), polyurethanes (thermoplastic polyurethane elastomers (TPU)), polyolefins (thermoplastic polyolefins (TPO)), crosslinked thermoplastic elastomers (thermoplastic elastomers made of thermoplastics and vulcanized elastomer (TPV)), styrene block copolymers (thermoplastic elastomers based on styrene block copolymers (TPS)), and silicones, individually or in combination. According to a preferred embodiment, the at least two contact surfaces comprise a styrene block copolymer (TPS).

Advantageously, the aforementioned materials enable the contact surfaces to secrete the coupling agent when a contact pressure is exerted on the contact surface by means of the flowmeter.

According to the present invention, the contact surfaces can be formed as a coating on a base body or measuring body. Such a coating can, for example, be designed as an overmolding of the base body. According to a preferred embodiment, the base body comprises polybutylene terephthalate. According to the invention, the coating can be solid, porous, or sponge-like, with the solid embodiment being preferred.

Preferably, the contact pressure exerted by the flowmeter on the contact surface is at least about 0.7 N/mm², preferably at least about 1 N/mm², and particularly preferably at least about 1.3 N/mm². Advantageously, the contact pressures allow the contact surfaces to secrete the coupling agent. Furthermore, higher contact pressures can lead to a more rapid secretion of the coupling agent. The contact pressure does not have to be applied to the entire contact surface(s). In particular, the contact pressure can be exerted on the contact surface(s) at points or on portions.

Furthermore, it can be provided that the at least two contact surfaces, which have a styrene block copolymer, have been exposed to gamma or X-ray irradiation. Advantageously, gamma or X-ray irradiation enables the necessary contact pressure at which the coupling agent is secreted through the contact surfaces to be reduced.

Preferably, it can be provided that the flowmeter has a holder for the measurement region, wherein in an open state of the flowmeter the measurement region can be received by the holder and/or can be removed from the holder, and wherein in a closed state of the flowmeter the measurement region is enclosed by the flowmeter at least in portions along the flow path. Furthermore, it can be provided that in the closed state of the flowmeter, the flowmeter exerts the contact pressure at least in portions on the at least two contact surfaces. In particular, the flowmeter can have a sensor, for example an ultrasonic transducer, which is arranged in the holder, wherein the contact pressure is exerted in particular on the region or regions of the at least two contact surfaces which lie in the signal path of the sensor. Preferably, the contact pressure can be exerted substantially over half-surfaces of the at least two contact surfaces. In a further preferred embodiment, the contact pressure can be exerted substantially over the entire surfaces of the at least two contact surfaces.

Preferably, the contact surfaces can be arranged on the outside of the measurement region, wherein the normal vector of the contact surfaces preferably runs substantially perpendicular to the longitudinal axis of the flow-through device or main flow direction of the fluid through the flow-through device. Preferably, the at least two contact surfaces are arranged opposite one another with respect to the flow path.

Preferably, it can be provided that the measurement region, seen transversely to the flow path, has an overhang compared to the holder of the flowmeter in the closed state of the flowmeter. Advantageously, the overhang of the measurement region means that by closing the flowmeter, the holder of the flowmeter can exert a corresponding contact pressure on the contact surfaces. For example, the cross-sectional area of the flowmeter holder for the measurement region can be smaller than the cross-sectional area of the measurement region. Alternatively or optionally, the distance between the outer sides of the at least two contact surfaces can be greater than the corresponding distance between the inner sides of the flowmeter holder. The overhang can in particular be in a range of 0.5% to 2%, viewed on the cross-sectional area of the measurement region or viewed on the distance between the outer sides of the at least two contact surfaces. Preferably, the overhang can exist over the entire length of the contact surfaces.

Preferably, it can be provided that the measurement region has six contact surfaces which extend at least in portions along the flow path, wherein the six contact surfaces are arranged relative to one another in such a way that the flow path has a substantially hexagonal cross section, preferably an equilateral hexagonal cross section.

Preferably, it can be provided that the holder has a substantially hexagonal cross section, preferably an equilateral hexagonal cross section, in the closed state of the flowmeter. In particular, the holder can be designed to be complementary to the measurement region or the contact surfaces.

Preferably, it can be provided that the measurement region has a preferably monolithic measuring body on which the contact surfaces are attached or arranged. In particular, the measuring body can be coated with the contact surfaces. The measuring body can further have a channel which forms part of the flow path. In particular, the measuring body can be completely enclosed by the contact surfaces, in particular the six contact surfaces, at least in portions along the main flow direction. The contact surfaces can in particular be flat, i.e. the length and width of the contact surfaces are significantly larger than their thickness. In particular, the contact surfaces can have a minimum thickness of approximately 1.2 mm and a maximum thickness of approximately 1.5 mm. Furthermore, the contact surfaces can each have an area of approximately 30 mm² up to 200 mm², preferably about 40 mm² up to 160 mm².

Preferably, it can be provided that the measuring body is essentially dimensionally stable when the contact pressure is applied. Advantageously, the dimensionally stable design of the measuring body ensures that the measuring body is not deformed due to the contact pressure and that the contact pressure acting on the contact surfaces can be maintained. The measuring body can in particular be made of a thermoplastic material, in particular polybutylene terephthalate (PBT). The measuring body can preferably be manufactured by an injection molding process, for which polybutylene terephthalate is particularly suitable as a material for the measuring body.

Preferably, it can be provided that the coupling agent comprises an external plasticizer and/or extender that is liquid or that liquefies under pressure, wherein optionally the external plasticizer and/or extender that is liquid or that liquefies under pressure is oily. Oily means an organic liquid that does not mix with water. In particular, the coupling agent can be selected from the group consisting of bis(2-ethylhexyl) phthalate, mesamoll, mesamoll II, paraffin/mineral oil, polysiloxane or silicone oil, individually or in combination. According to a preferred embodiment, white oil or paraffin is extracted or secreted from the thermoplastic elastomer (TPE) according to the invention.

Preferably, it can be provided that the flowmeter has a first housing part and a second housing part which is movable relative to the first housing part, and wherein the first and second housing parts together form the holder for the measurement region or measuring body. Preferably, the first housing part and/or second housing part can have a recess which forms the holder.

The first connection, the second connection, and the measurement region or measuring body can be formed in one piece, e.g. as an injection-molded part. Alternatively, it can be provided that the first connection and the second connection can be detachably connected to the measurement region. The flow-through device can have securing elements with which the first connection and the second connection can be detachably connected to the measurement region or secured to it.

Furthermore, the first connection and the second connection can be designed so that the line can be fastened to the connections in a self-locking manner. Thus, the first and second connections can each be designed as a hose connector or hose barb in order to attach the line to the first and/or second connection.

A second aspect relates to a flow-through device for arranging on a fluid-conducting line and for attaching a flowmeter, in particular an ultrasonic flowmeter, for detecting a measurement variable of the fluid conducted by the line, wherein said flow-through device has:
a first and a second connection by means of which the flow-through device can be connected to the fluid-conducting line,
a measurement region arranged between the first connection and the second connection, which can be coupled to the flowmeter for detecting the measurement variable, wherein the first connection, the measurement region and the second connection define a flow path for the fluid through the flow-through device,
wherein the measurement region has at least two contact surfaces which extend at least partly along the flow path for contacting the flowmeter,
wherein the at least two contact surfaces are designed to secrete a coupling agent when a contact pressure is applied.

The flow-through device can further be developed according to the first aspect.

A third aspect relates to a use of a flow-through device according to the second aspect for detecting a measurement variable of the fluid conducted by a fluid-conducting line, wherein the following are provided:
arranging the flow-through device on the line;
attaching a flowmeter to the measurement region,
   wherein due to the attachment of the flowmeter to the measurement region, the flowmeter exerts at least the contact pressure on the contact surfaces.

Furthermore, the use can provide for carrying out a flow measurement by means of the flowmeter.

Further features, details and advantages of the invention result from the following description and from the drawings, which show exemplary embodiments of the invention. Corresponding objects or elements are provided with the same reference signs in all figures. In the figures:

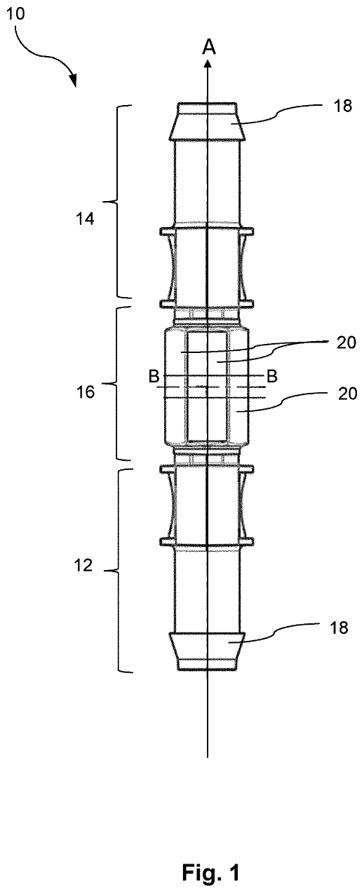

FIG. 1 shows a plan view of a flow-through device for arranging on a fluid-conducting line and for attaching a flowmeter, and

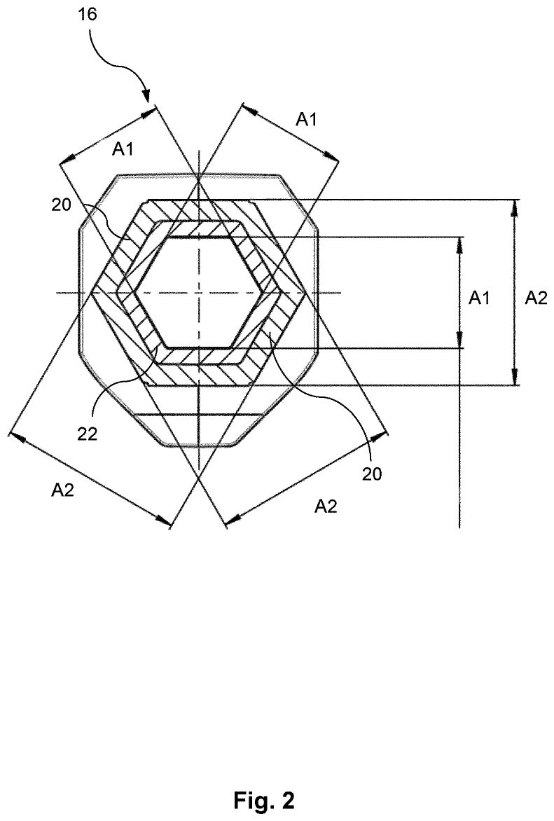

FIG. 2 shows a cross-sectional view of the flow-through device.

FIG. 1 shows a plan view of a flow-through device 10 for arranging on a fluid-conducting line (not shown) and for attaching a flowmeter (not shown). The flow-through device 10 has a first and a second connection 12/14, with which the flow-through device 10 can be arranged on a fluid-conducting line or between two fluid-conducting lines. For example, the first connection 12 can be connected to a fluid-conducting line, such as a plastic hose, wherein a fluid or medium can be supplied to the flow-through device 10 by means of the line. Furthermore, the second connection 14 can also be connected to a fluid-conducting line into which the fluid or medium flows from the flow-through device 10 via the second connection 14. In particular, it can be provided that the fluid is in liquid form, and solid particles, such as cell parts, can also be present in the fluid. The first and second connections 12/14 can each be designed such that the line can be fastened to the connections 12/14 in a self-locking manner. For example, the first and second connections 12/14 can each be designed as a hose connector or hose barb 18.

Between the first and second connection 12/14, a measurement region 16 is arranged on which the flowmeter (not shown) can be arranged or to which the flowmeter can be coupled. The first connection 12, the measurement region 16, and the second connection 14 define a flow path A through which a fluid or medium can flow through the flow-through device 10. The first connection 12, the measurement region 16, and the second connection 14 can in particular form a channel or flow channel 24 (see FIG. 2) which defines the flow path A. The flow path A or the channel 24 can in particular be elongated. Preferably, the flow path A runs substantially in a straight line, so that the main flow direction A of the fluid or medium through the flow-through device 10 is substantially constant.

In the embodiment shown in FIG. 1, the flow-through device 10 is formed in one piece. However, the flow-through device 10 can also be of modular construction, wherein the first and second connections 12/14 are each designed as hollow bodies and can be detachably connected to the measurement region 16. Securing elements can be provided for fastening or securing the first or second connection 12/14 to the measurement region 16. For example, each connection 12/14 can be attached to the measurement region 16 with a union nut.

The measurement region 16 has a measuring body 22 to which at least two contact surfaces 20 are applied or attached, wherein the contact surfaces 20 are oriented outwards. In particular, the normal vector of each contact surface 20 can be substantially perpendicular to the main flow direction A or perpendicular to the longitudinal direction of the measuring body 22. Furthermore, the at least two contact surfaces 20 can extend at least in portions along the flow path A or main flow direction A. Preferably, the contact surfaces 20 are arranged opposite one another with respect to the flow path A and in particular run parallel to one another. In the embodiment shown in FIG. 1, the measurement region 16 has six contact surfaces 20, which are arranged hexagonally as seen in the direction of the main flow direction A (see FIG. 2). In particular, two opposite contact surfaces 20 form a contact surface pair, so that the measurement region 16 has three contact surface pairs. Furthermore, the measuring body 22 can be monolithic and/or enclose the flow path A along the main flow direction at least in portions.

The flow-through device 10 can in particular be coupled to a flowmeter (not shown). Preferably, it can be provided that the flowmeter has a first housing part and a second housing part, which is movable relative to the first housing part, and wherein the first and second housing parts form a holder to which the measurement region 22 can be coupled. In particular, the first and second housing parts can each have a recess, which together form the holder for the measurement region 16 or measuring body 22. When the flowmeter is closed, the holder of the flowmeter contacts the contact surfaces 20 so that an input signal, for example an ultrasonic signal, can be input into the measurement region 16 via the contact surfaces 20 via a sensor provided in the holder, for example an ultrasonic transducer. Furthermore, the sensor system can receive an output signal based on the input signal via the contact surfaces 20 and determine a fluid-related measurement variable based on a comparison of the input and output signals.

FIG. 2 shows a cross-sectional view of the measurement region 16 along the BB line shown in FIG. 1. The measurement region 16 or the measuring body 22 can in particular be designed as an elongated hollow body whose longitudinal axis is substantially parallel to the main flow direction A. The measuring body 22 forms a part of the channel 24 and thus a part of the flow path A through which the fluid or medium flows. The channel 24 can also be enclosed by the contact surfaces 20 at least in portions along the main flow direction A.

Furthermore, the flow path A can have a substantially hexagonal cross section in the region of the measurement region 16 or the contact surfaces 20. However, the invention is not limited to a hexagonal cross section. For example, the cross section of the flow path A in the region of the measurement region 16 or the contact surfaces 20 can be substantially rectangular, in particular square. For this purpose, the measurement region can have only four contact surfaces 20, which are arranged in a rectangular or square shape when viewed in cross section.

Furthermore, the contact surfaces 20 are preferably rectangular, wherein the longitudinal direction of the contact surfaces 20 runs substantially parallel to the main flow direction A of the fluid or medium through the flow-through device 10 or runs parallel to the longitudinal direction of the flow-through device 10.

The flowmeter is designed such that its holder and in particular the recesses of the first and second housing parts exert a contact pressure on the contact surfaces 20 when the flowmeter is closed. The contact surfaces 20 have a material characteristic for releasing or secreting a preferably liquid coupling agent under contact pressure, which agent fills cavities that are present between the contact surfaces 20 and the holder or the recesses.

The contact pressure exerted by the flowmeter on the contact surface can be at least about 0.7 N/mm², preferably at least about 1 N/mm², and particularly preferably at least about 1.3 N/mm². In particular, the contact pressure can be exerted in that the measurement region has an overhang compared to the recesses when the flowmeter is closed. For example, the cross-sectional area of the measurement region 16 transverse to the flow path A can be larger than the cross-sectional area enclosed by the holder or recesses of the flowmeter.

Preferably, the at least two contact surfaces 20 can comprise an elastomer and/or thermoplastic elastomer, wherein optionally the thermoplastic elastomer is selected from the group consisting of polyether block amides (thermoplastic polyether block amides (TPA)), (co)polyesters (thermoplastic copolyester elastomers (TPC)), polyurethanes (thermoplastic polyurethane elastomers (TPU)), polyolefins (thermoplastic polyolefins (TPO)), crosslinked thermoplastic elastomers (thermoplastic elastomers made of thermoplastics and vulcanized elastomer (TPV)), styrene block copolymers (thermoplastic elastomers based on styrene block copolymers (TPS)), and silicones, individually or in combination. The coupling agent secreted from the contact surfaces can comprise an external plasticizer and/or extender that is liquid or that liquefies under pressure. Furthermore, the external plasticizer and/or extender that is liquid or that liquefies under pressure can be oily.

Preferably, the measuring body 22 can be substantially dimensionally stable when the contact pressure is applied. For example, the measuring body 22 can be made of a thermoplastic material, in particular of polybutylene terephthalate. Advantageously, the dimensionally stable design of the measuring body 22 ensures that the measuring body 22 is not deformed due to the contact pressure and that the contact pressure acting on the contact surfaces 20 can be maintained. The measuring body 22 can preferably be manufactured by an injection molding process, for which polybutylene terephthalate is particularly suitable as a material for the measuring body 22.

The contact surfaces 20 can have a length, viewed in the longitudinal direction of the flow-through device 10, of approximately 10 mm to 50 mm and a width, viewed transversely to the longitudinal direction of the flow-through device 10, of approximately 3 mm to 20 mm. Furthermore, the contact surfaces 20 can have a minimum thickness of about 1.2 mm and/or a maximum thickness of about 1.5 mm. The distance A1 between two opposite inner sides of the channel 24 can be between 2 mm and 12 mm. Furthermore, the distance A2 between the outer sides of two opposite contact surfaces 20 can be between approximately 6 mm and 35 mm.

### LIST OF REFERENCE SIGNS

10 Flow-through device for arrangement on a fluid-conducting line
12 First connection
14 Second connection
16 Measurement region
18 Hose connector
20 Contact surfaces
22 Measuring bodies
24 Channel
A Flow path or main flow direction/longitudinal direction of the flow-through device

1. A system for detecting a measurement variable of the fluid conducted by a fluid-conducting line, said system having:
a flowmeter, in particular an ultrasonic flowmeter, for detecting the measurement variable,
a flow-through device for arranging on the fluid-conducting line and for attaching the flowmeter for detecting the measurement variable of the fluid conducted by the line, wherein the flow-through device has:
a first and a second connection by means of which the flow-through device can be connected to the fluid-conducting line,
a measurement region arranged between the first connection and the second connection, which can be coupled to the flowmeter for detecting the measurement variable, wherein the first connection, the measurement region and the second connection define a flow path for the fluid through the flow-through device,
wherein the measurement region has at least two contact surfaces which extend at least partly along the flow path for contacting the flowmeter,
wherein the at least two contact surfaces are designed to secrete a coupling agent when a contact pressure is applied, and
wherein the flowmeter is designed such that by coupling the flowmeter to the measurement region, the flowmeter exerts at least the contact pressure on the at least two contact surfaces.

2. The system according to claim 1, wherein the at least two contact surfaces comprise an elastomer and/or thermoplastic elastomer.

3. The system according to claim 1, wherein the contact pressure is at least about 0.7 N/mm².

4. The system according to claim 1, wherein the flowmeter has a holder for the measurement region, wherein in an open state of the flowmeter the measurement region can be received by the holder and/or can be removed from the holder, and wherein in a closed state of the flowmeter the measurement region is enclosed by the flowmeter at least in portions along the flow path.

5. The system according to claim 4, wherein the measurement region, seen transversely to the flow path, has an overhang compared to the holder in the closed state of the flowmeter.

6. The system according to claim 1, wherein the measurement region has six contact surfaces which extend at least in portions along the flow path, wherein the six contact surfaces are arranged relative to one another such that the flow path has a substantially hexagonal cross section.

7. The system according to claim 4, wherein the holder in the closed state of the flowmeter has a substantially hexagonal cross section.

8. The system according to claim 1, wherein the measurement region has a preferably monolithic measuring body to which the contact surfaces are attached.

9. The system according to claim 1, wherein the measuring body is substantially dimensionally stable under the action of the contact pressure, and/or wherein the measuring body is made of a thermoplastic material.

10. The system according to claim 1, wherein the coupling agent comprises an external plasticizer and/or extender that is liquid or that liquefies under pressure, wherein the external plasticizer and/or extender that is liquid or that liquefies under pressure is oily.

11. The system according to claim 10, wherein the coupling agent comprises white oil or paraffin.

12. The system according to claim 4, wherein the flowmeter has a first housing part and a second housing part which is movable relative to the first housing part, and wherein the first and second housing parts together form the holder for the measurement region.

13. The system according to claim 1, wherein the first connection and the second connection are detachably connectable to the measurement region.

14. A flow-through device for arranging on a fluid-conducting line and for attaching an ultrasonic flowmeter, for detecting a measurement variable of the fluid conducted by the line, wherein the flow-through device has:
a first and a second connection by means of which the flow-through device can be connected to the fluid-conducting line,
a measurement region arranged between the first connection and the second connection, which can be coupled to the flowmeter for detecting the measurement variable, wherein the first connection, the measurement region and the second connection define a flow path for the fluid through the flow-through device,
wherein the measurement region has at least two contact surfaces which extend at least partly along the flow path for contacting the flowmeter,
wherein the at least two contact surfaces are configured to secrete a coupling agent when a contact pressure is applied.

15. A use of a flow-through device according to claim 14 for detecting a measurement variable of the fluid conducted by a fluid-conducting line, wherein the following are provided:
arranging the flow-through device on the line; and
attaching a flowmeter to the measurement region, wherein due to the attachment of the flowmeter to the measurement region, the flowmeter exerts at least the contact pressure on the contact surfaces.

16. The system according to claim 1, wherein the thermoplastic elastomer is selected from the group consisting of polyether block amides, (co)polyesters, polyurethanes, polyolefins, crosslinked thermoplastic elastomers, styrene block copolymers, and silicones, individually or in combination

17. The system according to 1, wherein the contact pressure is at least about 1 N/mm².

18. The system according to claim 1, wherein the contact pressure is at least about 1.3 N/mm².
